(19) United States
(12) Patent Application Publication
(10) Pub. No.: US 2014/0213223 A1
(43) Pub. Date: Jul. 31, 2014

(54) ENHANCED SIGNALING FOR MOBILE COMMUNICATION DEVICES

(71) Applicants: Shreedhar Madhavapeddi, Seattle, WA (US); John F. Pollard, Seattle, WA (US); Gary B. Clayton, San Francisco, CA (US); Pim van Meurs, Kenmore, WA (US)

(72) Inventors: Shreedhar Madhavapeddi, Seattle, WA (US); John F. Pollard, Seattle, WA (US); Gary B. Clayton, San Francisco, CA (US); Pim van Meurs, Kenmore, WA (US)

(73) Assignee: NUANCE COMMUNICATIONS, INC., Burlington, MA (US)

(21) Appl. No.: 14/141,375

(22) Filed: Dec. 26, 2013

Related U.S. Application Data
(62) Division of application No. 13/210,278, filed on Aug. 15, 2011, now abandoned.

(51) Int. Cl. H04M 3/533; H04M 3/42; H04W 4/02

(52) U.S. Cl. CPC H04M 3/533; H04W 4/025; H04M 3/42357
USPC 455/412.2

(57) ABSTRACT

A data communication system routes calls from a mobile communication device associated with a calling party to a mobile communication device associated with a called party. If calls are not answered by the called party, a call is routed to a voicemail server. A data channel is opened between the mobile communication device associated with the calling party and the voicemail server over which higher fidelity audio signals are transmitted. The transmitted audio is supplied to the voicemail server for conversion from an audio to a text format. In accordance with another aspect, a data channel is opened with a call placed by the calling party. The data channel is used to append information that is sent with a call to give the called party information regarding the call or the caller without having to answer the call.

### RELATED APPLICATIONS

This application is a divisional of U.S. patent application Ser. No. 13/210,278, filed Aug. 15, 2011, which is incorporated herein by reference.

### TECHNICAL FIELD

The disclosed technology relates to communication systems in general and in particular to enhanced signaling systems for mobile communication devices.

### BACKGROUND

As the processing power of mobile communication devices and the speed of carrier networks improve, users expect corresponding increases in communication quality. While the placement of additional cell sites throughout a geographic region reduces the likelihood of a dropped call, the quality of a mobile call may not be as good as the user would experience with a land line call. One area in which this reduced quality audio is particularly noticeable is with voicemail recordings received from a mobile device (particularly if a mobile device is moving between the periphery of two cell sites).

FIG. 1 shows a conventional mobile communication system in which a calling party associated with a mobile communication device A wishes to contact or place a telephone call to a called party associated with a mobile communication device B. A call placed by the calling party is routed through a mobile switching center 10 that serves to direct the call to the called party. A home location register (HLR) associated with the mobile switching center 10 is used to store the location of the mobile communication devices so that the mobile switching center can determine where or on what network the mobile communication signals should be broadcast in order to reach the called party. Upon placing a call to the called party, the called party's mobile communication device B rings or performs some other action (e.g., vibrates) to alert the called party that they have received the call. The mobile switching center 10 or other network processor determines when the called party has either not answered their phone after a predetermined number of rings or if the called party has requested that their telephone calls be routed to another device. If the called party has voicemail, the call is generally routed by the mobile switching center 10 to a voicemail system 14.

If the calling party elects to leave a voicemail message for the called party, audio signals are captured and transmitted over an audio voice channel 12a that is set up for the call. The voicemail system then records and stores the audio signals for retrieval by the called party. In addition, the voicemail system 14 can interact with a voicemail transcription server 16 over a network. The voicemail transcription sever 16 performs a speech-to-text conversion of the received audio message. Once the voicemail message is recorded, the network sends a message to the called party indicating that they have received a voicemail message. The called party then requests to receive the recorded audio voicemail message over another audio voice channel 12b. The transcribed voicemail message may be sent to the called party as a text message.

### BRIEF DESCRIPTION OF THE DRAWINGS

FIG. 1 illustrates a conventional mobile communication system including a voicemail server.

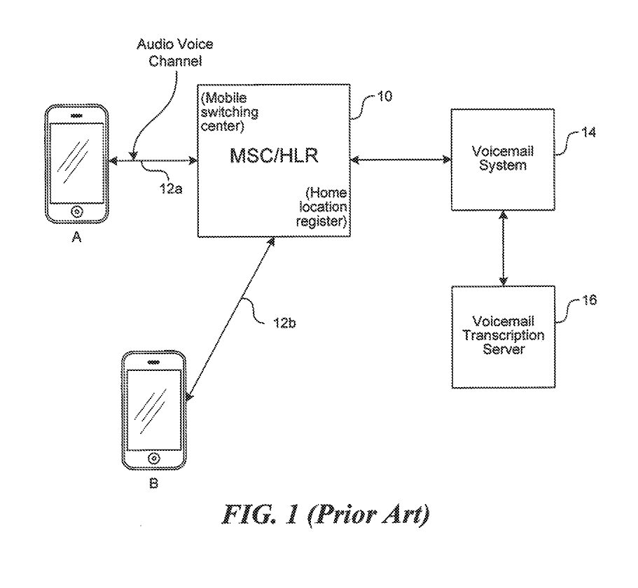

FIG. 2 illustrates a mobile communication system in accordance with an embodiment of the disclosed technology.

FIG. 3 is a flow chart of steps performed by a programmed processor in accordance with an embodiment of the disclosed technology.

FIG. 4 shows illustrative user interface screens presented by a mobile communication device in accordance with an embodiment of the disclosed technology.

FIG. 5 shows illustrative user interface screens presented by a mobile communication device in accordance with an embodiment of the disclosed technology.

FIG. 6 shows illustrative user interface screens presented by a mobile communication device in accordance with an embodiment of the disclosed technology.

### DETAILED DESCRIPTION OF THE PREFERRED EMBODIMENTS

As will be discussed in further detail below, the technology described herein relates to an improved mobile communication system. In accordance with one embodiment of the technology, increased fidelity audio data are sent to a voicemail server for recording and conversion from an audio to a text format. When a user in the network places a call, the cellular network determines if the call was answered by the called party. If not, the call is routed to a voicemail server. In one embodiment, the voicemail server stores a record of mobile communication devices that are equipped with the ability to stream digital audio signals. If the mobile communication device of the calling party has this ability, the voicemail server causes a busy signal, error code or other signal to be sent to the mobile communication device of the calling party. This signal causes the calling party's mobile communication device to request the opening of a data channel. Digitized audio signals are recorded by the mobile communication device and are streamed on the opened data channel to the voicemail server. The audio data are received by the voicemail server on the data channel and are stored and transcribed.

After the transcription is complete, the network sends a message to a communication device of the called party indicating that they have received a voicemail message. The called party can then retrieve their audio voicemail message and/or the transcribed message.

In some embodiments, the voicemail server may interface with a conventional voicemail system in order to store audio voicemail messages for users having communication devices that do not support sending or receiving digital audio signals over data channels.

In another embodiment, a data channel is used to send additional information with a call. Such information can include such things as the purpose of the call, the location of the calling party or the like. In one embodiment, a dialing application that runs on a mobile communication device of a calling party requests the opening of a data channel when a call is made. The data channel is used to send the additional information for the call to the called party without requiring the called party to answer the call.

Some of the problems associated with the conventional transcription of voicemail messages occur due to the quality of the audio data that is supplied to a voicemail transcription server over a lower bandwidth (e.g., 8-bit) audio channel. Because the quality of the voice signals that are input to the transcription server over a voice channel are low, the voicemail transcription server 16 may have difficulty in accurately interpreting the spoken messages left by a calling party.

To improve the quality of transcribed voicemail messages, one embodiment of the disclosed technology operates to transmit higher fidelity audio signals to a voicemail server over a data channel.

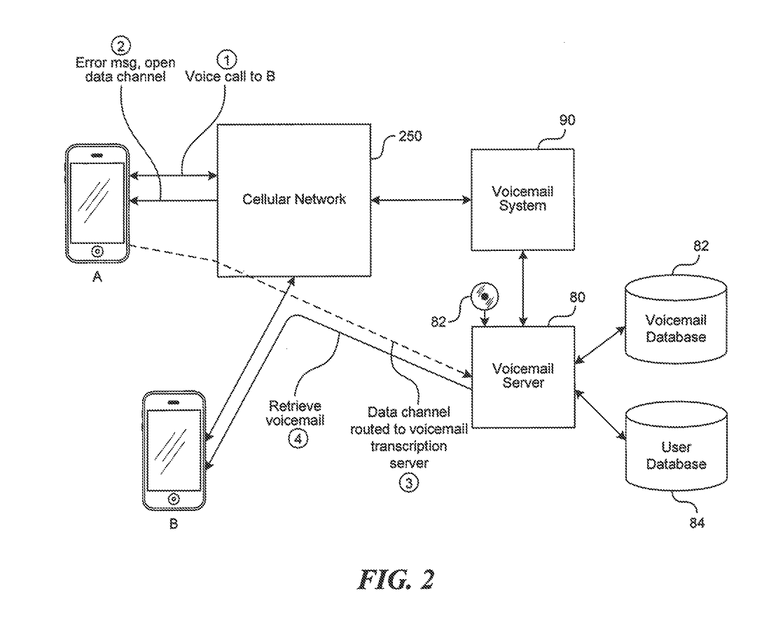

As shown in FIG. 2, a mobile communication system in accordance with one embodiment of the disclosed technology includes two or more mobile communication devices A and B associated with a calling party and a called party respectively. The mobile communication devices can be cellular telephones, satellite telephones, wireless telephone handsets, personal digital assistants (PDAs) or other devices that are equipped with the appropriate hardware and software that allows a user to place and receive telephone calls. Although the technology is generally described with respect to calls carried over cellular telephone networks, it will be appreciated that the technology can easily be adapted for use with other transmission channels such as voice-over internet protocol (VOIP) channels.

In the illustrated embodiment shown, a cellular network 50 routes telephone calls between users of the network. The cellular network determines when a call is not answered. If the called party has voicemail service, the cellular network routes the call to a voicemail server 80. The voicemail server 80 keeps a record of those mobile communication devices that are equipped with the appropriate software and hardware required to stream audio signals. The hardware/software may be designed into the mobile communication device when it was manufactured, or specialized software may be installed afterwards (e.g. a piece of code). The hardware/software of the mobile communication device provides the ability to receive a signal from the voicemail server and request the opening of a data channel to connect to the voicemail server 80. Once the data channel is open, the mobile communication device of the calling party begins recording digitized audio signals and streaming the signals to the voicemail server. The audio signals are recorded with the built-in microphone and digitized with the analog-to-digital converters located within the mobile communication device in order to produce high fidelity digital audio data.

The voicemail server 80 includes an automated speech recognition (ASR) engine or speech-to-text transcription system to convert received audio signals to text. (Alternatively or additionally, the mobile device A may include audio transcription software available from Nuance Communications, Inc. of Burlington, Mass., the assignee of the present application.)

In some embodiments, the cellular network 50 may not operate to route every unanswered call to the voice mail server. In that case, it is possible for mobile communication devices to request that calls be routed to the voicemail server 80 using a redirection code. As will be understood by those of ordinary skill in the art, redirection of a call is typically requested by entering a special string of characters/symbols along with a code that indicates where the call is to be directed. For example, upon receipt of a busy signal, the dialing program of a mobile communication device may be programmed to generate a redirection string such as *004*4252460150# in order to redirect a call to a voicemail server having an access number 4252460150. The particular details of which strings are required and their format depends on the signaling protocol used in the communication system (e.g., SS7) and the network type (e.g., GSM, CDMA, etc.).

In one embodiment, the cellular network 50 causes the mobile communication device A of the calling party to request a redirection of the call by sending a busy signal, an error code, or other signal to the mobile communication device A. In response, the dialer software on the mobile communications device can send a redirection code to the cellular network asking to be connected to the voicemail server 80.

Once the mobile communication device of the calling party is connected to the voicemail server 80, the voicemail server determines if the mobile communication device is a “rich client” (e.g. if the mobile communication device has the appropriate hardware and software required to stream audio signals to the voicemail server over a data channel). If so, the voicemail server sends a signal, such as an error code to the mobile communication device that causes the mobile communication device to request the opening of a data channel. Depending on the signaling protocol of the network, there are generally many un-used error codes that can be used instruct the connected mobile communication device to request the opening of a data channel.

In one embodiment, software is included in a custom dialer program that runs on the mobile communication device to detect the receipt of the error code from the voicemail server. In yet another embodiment, the software/hardware is incorporated into the design of the mobile communication device.

In one embodiment, an application program running in conjunction with the operating system of the mobile communication device detects the receipt of a designated error code from the voicemail server and operates to launch an audio recording program as well as request the opening of the data channel to the voicemail server 80.

Once the data channel is opened, an audio recording program operating on the mobile communication device begins digitizing audio signals captured by the mobile communication device's microphone and streaming the digitized audio data over the open data channel. Because the data channel has a higher bandwidth than an audio voice channel, increased amounts of information can be transmitted and the quality of the transmitted audio data is higher than if the audio data were transmitted over a voice channel. The voicemail server 80 applies one or more audio-to-text conversion algorithms to the data in order to convert the received digital data signals into transcribed text. The voicemail server can also store the digitized audio data in a memory or in a user database 82 without converting the speech to text so that the audio voicemail recording can be retrieved by a called party if desired.

In one embodiment, the voicemail server 80 is associated with a user database 84 that stores training data or other information useful to the speech-to-text conversion algorithms in order to allow the algorithms to better transcribe the audio signals received from the calling party. For example, the user database 84 may store words commonly used by the calling party, records of inflections, accents, or other information useful in accurately converting speech to text. The database 84 may also store contact information of individuals associated with the calling party so that if the transcription algorithm has to decide the likely name of a person, the decision can be guided by the names of the people in the contact list. Further details may be found in the assignee's U.S. patent application Ser. No. 13,190,749, filed Jul. 26, 2011, entitled SYSTEMS AND METHODS FOR IMPROVING THE ACCURACY OF A TRANSCRIPTION USING AUXILIARY DATA SUCH AS PERSONAL DATA (attorney docket number 71007.8051US), which application is incorporated by reference herein.

In some embodiments, the speech to text algorithms operating on the voicemail server 80 can be accessed by other computing devices associated with the calling party such as their personal computer. In this way, the training data etc. that is stored for the calling party may be obtained by the voicemail server in other manners besides via the mobile communication devices.

In some embodiments, the voicemail server 80 allows a user to preview a transcribed voicemail message prior to its delivery to the called party. The transcribed voicemail message can be sent back to the calling party either on the data channel that was opened or via some other communication protocol, such as by SMS (e.g., text) message, e-mail or the like. In this embodiment, once the calling party has approved the content of the transcribed voicemail message, a notification is sent to the called party that indicates that they have received a voicemail message.

The voicemail server 80 also determines if the mobile communication device of the called party has the ability to receive information on a data channel. If so, when the called party associated with the mobile communication device B has a voicemail message waiting, the voicemail server sends, or causes the cellular network to send, a signal to the mobile communication device that causes the mobile communication device to request the opening of a data channel to the voicemail server 80. The transcribed voicemail message can then be transmitted from the voicemail server 80 to the called party via the open data channel. Alternatively, or in addition, the called party may elect to retrieve the stored audio voice message. In one embodiment, the stored audio message is transmitted on the data channel. In an alternative embodiment, the stored audio message may be transmitted on a lower quality voice channel. In yet another alternative embodiment, the user can receive both the audio voicemail message and the transcribed voicemail message on the same or different channels.

In one embodiment of the disclosed technology, the voicemail server 80 interfaces with a conventional voicemail system 90 via a direct connection, a private computer communication link (e.g. a LAN) or a public computer communication link (e.g. the Internet). Transcribed voicemail messages and/or recorded audio messages stored by the voicemail server 80 may be forwarded to the voicemail system 90 so that users having mobile communication devices that cannot receive data on a digital data channel can still retrieve their voicemail messages. In that case, when a called party has a message waiting, the mobile communication device contacts the voicemail system 90 in the conventional manner to retrieve their recorded voicemail message.

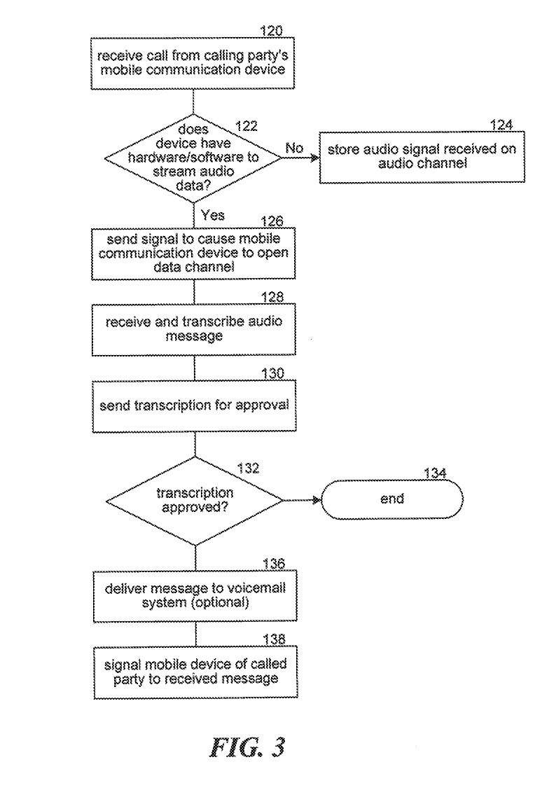

FIG. 3 is an illustrative flowchart of steps performed by one or more programmed processors in the voicemail server to transcribe recorded voicemail messages. As will be appreciated by those of ordinary skill in the art, the processors are configured to execute instructions that are stored on a non-transitory computer readable media 82 (e.g., CD, hard-drive, flash memory, solid state memory, or the like). Alternatively, the instructions could be received on a computer communication link such as the Internet. While generally described herein as being performed by the voicemail server, some or all aspects of the steps in FIG. 3 may be performed by other programmed processors in (or connected to) the cellular network 50.

Beginning at 120, the voicemail server receives a call that has been routed by the cellular network in response to an unanswered call. At 122, the programmed processor determines if the mobile communication device of the calling party has the hardware/software required to stream audio signals on a data channel to the voicemail server. If not, the processor causes audio signals received on an audio channel to be stored in memory at 124. In addition, the stored signals may be transcribed in the conventional manner.

If the mobile communication device of the calling party can stream audio signals, the programmed processor causes a signal to be sent to the mobile communication device at 126. This signal causes the mobile communication device to request the opening of a data channel to the voicemail server over which audio signals are streamed. At 128, the processor receives and transcribes the streamed audio signals into corresponding text.

At 130, the processor causes the transcribed audio signals to be sent to the calling party for approval. If the transcription is not approved, processing ends at 134. If the transcription is approved, then the processor may send the recorded audio and transcribed message to a voicemail system in order to be retrieved by feature phones (i.e. phones that do not support opening a data channel on which the message can be retrieved). This step may be optional.

At 138, the programmed processor causes a signal to be sent to the mobile communication device of the called party to indicate that the called party has received a message.

Once a called party is notified that they have received a voicemail message, the mobile communication device of the called party requests the opening of a data channel between the mobile communication device associated with the called party and the voicemail server. Once the data channel is open, the transcribed voicemail message is forwarded to the mobile communication device of the called party. In addition, or alternatively, the called party may request the stored audio voicemail message be transmitted in either a high fidelity format over the data channel or in a lower fidelity format over a conventional audio channel. If the mobile communication device of the called party does not have the ability to receive data on a data channel, the called party can retrieve the recorded voicemail message from the voicemail system in the conventional manner.

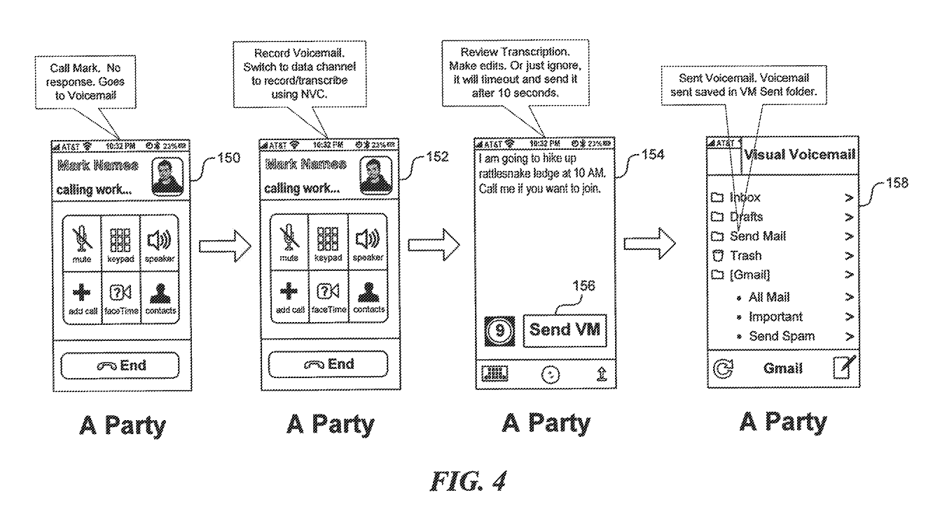

FIG. 4 illustrates a number of representative user interface screens that may be presented by a dialing application running on a mobile communication device. A screen 150 shows a number of controls produced by the dialing application to allow a user to place a call to a called party. If the call is not answered, the calling party can record a voicemail message for the called party. As indicated above, the mobile communication device of the calling party requests the opening of a data channel between the mobile communication device and a voicemail server. Audio signals are streamed to the voicemail server and transcribed into text.

Once the voicemail message is transcribed by the voicemail transcription sever, a message is sent back to the mobile communication device and displayed in a screen 154 for editing or approval. The calling party can approve the transcription by activating a control 156, which causes the mobile communication device of the calling party to send a signal to the voicemail server approving the message. Alternatively, the transcribed voicemail message may be automatically approved and delivered if the calling party does nothing within a predetermined time limit (e.g. 10 seconds). In one embodiment, once a message is delivered, a copy of the sent message is stored on the calling party's mobile communication device in a sent message folder as shown in user interface screen 158.

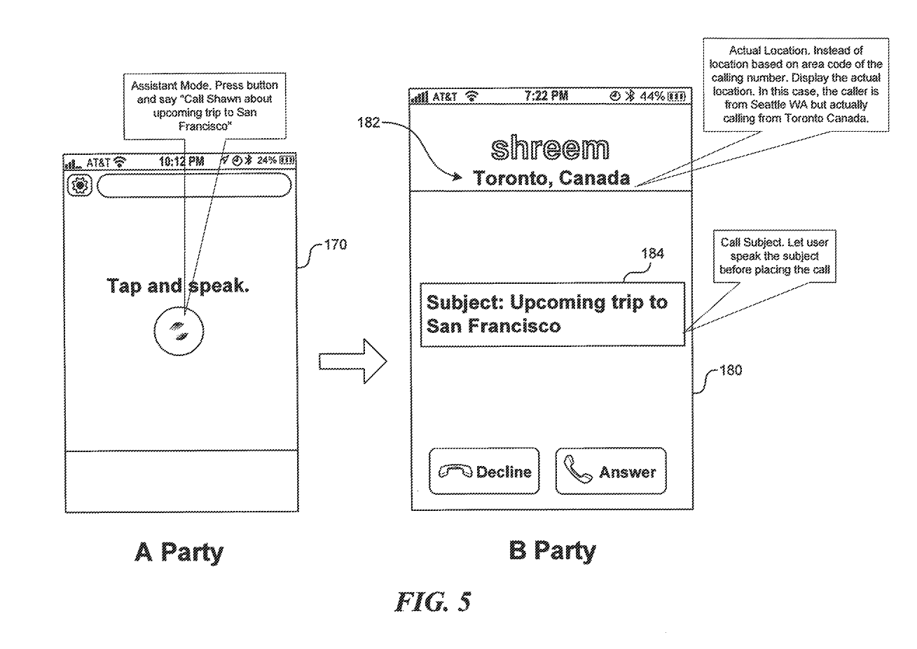

As indicated above, the data channel can also be used by a dialing application to pre-append information to a call prior to, or concurrently with, placing a call. FIG. 5 shows representative user interface screens presented by a dialing application associated with a mobile communication device of a calling party. In this embodiment, a screen 170 includes a control 172 that is activated by the calling party to record information about a call to be placed. The information may include voice commands that instruct the mobile communication device what to do. For example, the calling party can press the control 172 and say “Call Shawn at work regarding the trip to San Francisco” and the mobile communication device will dial the correct number for Shawn. Additional information can also be send on the data channel such the calling party's location. In the example shown in FIG. 5, a screen 180 is displayed on the called party's mobile communication device when a call is received. The screen shows the name of the calling party in the conventional fashion. In addition, the screen 180 shows the location of the calling party at 182 and the subject of the call at 184. This information may be useful to the called party in determining whether they should answer or decline the call. Other types of information that can be appended to a call may include information about the calling party's phone such as make and model etc. Such information may be useful in technical support environments. Other information may include locally stored payment information for completing monetary transactions, photographs, web pages or portions thereof. Still other information can include calendar information that is useful in making meeting requests. These examples are meant to be non-limiting and the technology can be used to append any type of information to a call that may be of use to the called party.

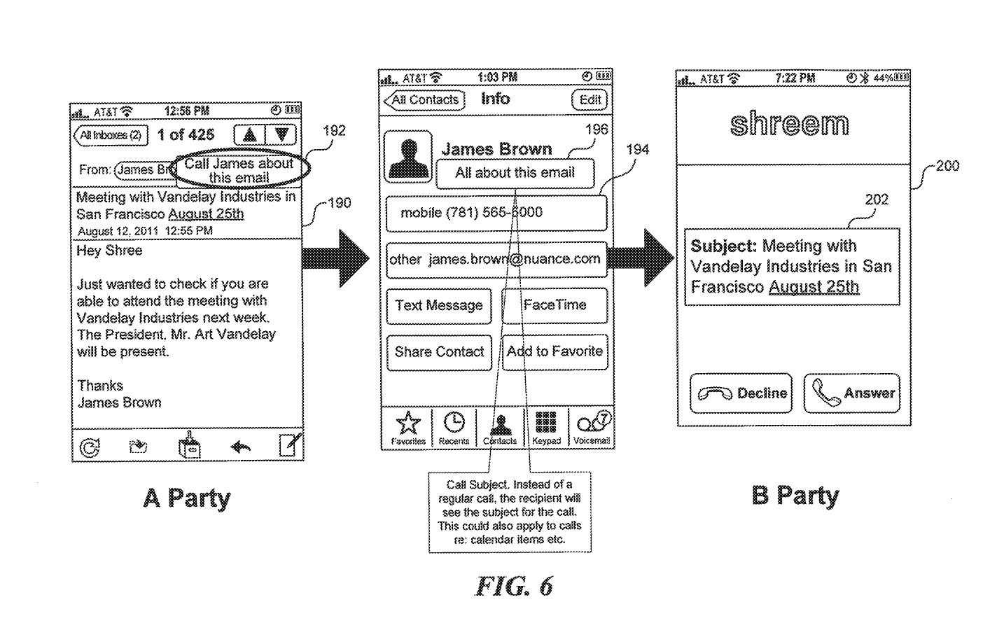

FIG. 6 illustrates representative user interface screens presented by a mobile communication device of a calling party that integrates the dialing program with other programs such as e-mail as shown in screen 190 or a calendar program etc. When a user views an e-mail screen, a control 192 is produced asking if the user wants to place a call to a person. If the user selects the control 192, a screen 194 is presented with the person's contact information along with a prompt 196 that allows the user to generate additional information that will be included with the call. In the example shown, the additional information concerns the subject of the e-mail that was received. If the calling party initiates the call, a data channel is opened and information regarding the reason for the call is sent to the called party's mobile communication device. In one embodiment, the dialing program presents a user interface screen that shows the reason for the call based on the context of the program that was operating on the calling party's mobile communication device when the call was initiated. For example, the reason for the call may be taken from the subject line of an e-mail or from the title of a meeting request etc.

At the calling party's mobile communication device, a user interface screen 200 is presented that contains the name of the calling party and a text box 202 that contains the additional information sent on the data channel. In this example, the text box includes the subject of the call.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

From the foregoing, it will be appreciated that specific embodiments of the disclosed technology have been described herein for purposes of illustration, but that various modifications may be made without deviating from the scope of the invention. Accordingly, the invention is not limited except as by the appended claims.

1-6. (canceled)

7. A mobile communication system, comprising one or more programmed processors that are configured to:
receive a request to place a call over a voice channel from a mobile communication device associated with a calling party to a mobile communication device associated with a called party;
open a data channel between the mobile communication device associated with the calling party and the mobile communication device associated with the called party; and
route information received from the mobile communication device associated with the calling party via the data channel to the mobile communication device associated with the called party along with an indication of an incoming call on the voice channel.

8. The mobile communication system of claim 7, wherein the one or more programmed processors are configured to route location information received on a data channel from the mobile communication device associated with the calling party to the mobile communication device associated with the called party.

9. The mobile communication system of claim 7, wherein the one or more programmed processors are configured to route textual message information received on the data channel from the mobile communication device associated with the calling party to the mobile communication device associated with the called party.

10. A non-transitory computer readable media including instructions that are executable by a processor in a mobile communication network in order to:
receive a request to place a call over a voice channel from a mobile communication device associated with a calling party to a mobile communication device associated with a called party;
open a data channel between the mobile communication device associated with the calling party and the mobile communication device of the called party; and
route information received from the mobile communication device associated with the calling party to the mobile communication device associated with the called party via the data channel along with an indication of an incoming call on the voice channel.

11-12. (canceled)

13. A mobile communication device including one or more processors that are configured to:
place a call to a communication device associated with a called party on a voice channel;
request the opening of a data channel between the mobile communication device and a communication device associated with the called party;
receive information to be transmitted with the call; and
send the information on the data channel.

14. The mobile communication device of claim 13, wherein the information includes a location of the mobile communication device of a calling party.

15. The mobile communication device of claim 13, wherein the information includes a subject of the call.

16. The mobile communication device of claim 13, wherein the information includes information about a calling party's mobile communication device.

17. The mobile communication device of claim 13, wherein the information includes information regarding the calling party's schedule.

18. The mobile communication device of claim 13, wherein the information includes information regarding payment information for a monetary transaction.

19. A non-transitory computer readable media with instructions that are executable by a processor in a mobile commutation device that when executed, cause the processor to:
place a call to a communication device associated with a called party on a voice channel;
request the opening of a data channel between the mobile communication device associated with the calling party and a communication device associated with the called party;
receive information to be transmitted with the call; and
send the information on the data channel.

20-21. (canceled)
